(19) United States
(12) Patent Application Publication
(10) Pub. No.: US 2013/0236809 A1
(43) Pub. Date: Sep. 12, 2013

(54) Direct Formate Fuel Cell Employing Formate Salt Fuel, An Anion Exchange Membrane, And Metal Catalysts

(71) Applicant: JOHN HAAN, FULLERTON, CA (US)

(72) Inventor: JOHN HAAN, FULLERTON, CA (US)

(73) Assignee: CALIFORNIA STATE UNIVERSITY, FULLERTON AUXILIARY SERVICES CORPORATION

(21) Appl. No.: 13/414,648

(22) Filed: Mar. 7, 2012

(51) Int. Cl. H01M 8/22; H01M 4/86; H01M 4/92; H01M 8/10; B82Y 30/00

(52) U.S. Cl. 429/482; 429/505; 429/504; 429/490; 977/773

(57) ABSTRACT

A direct formate fuel cell (DFFC) employs at least one formate salt as the anode fuel, either air or oxygen as the oxidant, a polymer anion exchange membrane (AEM) to separate the anode and cathode, and metal catalysts at the anode and cathode. One exemplary embodiment consists of palladium nanoparticle anode catalyst and platinum nanoparticle cathode catalyst, each applied to the alkaline AEM in the form of a thin film. Operation of the DFFC at 60° C. with 1 M KOOCH+2 M KOH as the anode fuel and electrolyte and oxygen at the cathode produces 144 mW cm⁻² of peak power density, 181 mA cm⁻² current density at 0.6 V, and an open circuit voltage of 0.931 V. This performance is competitive with alkaline direct liquid fuel cells (DLFCs) reported in the literature and demonstrates that formate fuel is a legitimate contender with alcohol fuels for alkaline DLFCs.

### BACKGROUND OF THE INVENTION

1. Field of the Invention

The present invention relates generally to fuel cells and more particularly to a direct formate fuel cell using a polymer anion exchange membrane.

2. Background Discussion

Development of the first commercial fuel cells in the 1960s revolved around two different hydrogen-oxygen fuel cells which possess the same overall chemistry:

H₂+½O₂→H₂O E_{cell}⁰=1.23V (1)

A fuel cell with an acid electrolyte passes H⁺ from anode to cathode:

H₂→2H⁺2e⁻ E_{anode}⁰=0.00V (2)

½O₂+2H⁺+2e⁻→H₂O E_{cathode}⁰=1.23V (3)

while a fuel cell with an alkaline electrolyte passes OH⁻ from cathode to anode:

H₂+2OH⁻→2H₂O+2e⁻ E_{anode}⁰=−0.83V (4)

½O₂+H₂O+2e⁻→2OH⁻ E_{cathode}⁰=0.40V (5)

The oxygen reduction reaction (Equation 3 or 5) limits the efficiency of a hydrogen-oxygen fuel cell. Since the reaction proceeds more rapidly in alkaline media, the alkaline fuel cell (AFC) is more efficient. Hydrogen-oxygen fuel cells containing liquid or solid electrolytes were used in the space program but suffered from engineering difficulties which were remedied by the development of Nafion®, a polymer ion exchange membrane which replaced a liquid or solid electrolyte. Nafion® permitted the miniaturization of fuel cells and improved their performance and durability. However, since Nation° is a proton exchange membrane (PEM), it is only capable of replacing the electrolyte in an acid fuel cell. Therefore, its creation shifted scientists' attention toward acid fuel cells, for which most research of the past several decades has been focused.

While hydrogen-oxygen fuel cells are very energy efficient, they are impractical for many portable power applications such as transportation and personal electronic devices. Hydrogen compression is energy inefficient, and safe hydrogen storage requires high-mass components. Therefore direct liquid fuel cells (DLFCs) are currently being commercialized for portable electronic devices such as wireless phones and laptop computers, and they are being researched for transportation applications (see Zhu—Ref. 1; Antolini—Ref. 2; Liu—Ref. 3). State of the art acid DLFCs possess a PEM and are fed by small organic molecule fuels such as methanol or formic acid:

CH₃OH+H₂O→CO₂+6H⁺6e⁻ E_{anode}⁰=0.02V (6)

HCOOH→CO₂+2H⁺2e⁻ E_{anode}⁰=−0.22V (7)

However, DLFCs using such fuels have several engineering challenges (see Christensen—Ref. 4; Bianchini—Ref. 5). First, the oxidation reactions are kinetically sluggish in acid media, especially in comparison to hydrogen oxidation. Second, the catalysts, which must be noble metals to survive the acid environment, are susceptible to poisoning. Third, the fuel tends to be dragged across the membrane along with the protons, particularly in the methanol fuel cell. Finally, the methanol fuel is toxic and the environment of both fuel cells is corrosive.

The alkaline environment of an AFC is ideal for direct operation using a small organic molecule fuel. For decades, the major roadblock to commercialization has been the lack of a practical polymer electrolyte anion exchange membrane (AEM). However, within the past few years, Tokuyama developed an AEM which has been demonstrated by a few scientists to operate a DLFC fueled by small organic molecules (see Bianchini—Refs. 5 and 6; Li—Ref. 7; Bambagioni—Ref. 8; Yu—Ref. 9). There are two key advantages of the polymer AEM membrane. First, the fuel cell is not susceptible to carbonation, which leads to formation of precipitates in alkaline fuel cells operated using a liquid electrolyte. Second, the membrane permits operation of a direct liquid fuel cell in an alkaline environment, where in comparison to an acid environment: (1) the oxidation of small organic molecules is more facile, (2) less expensive catalysts are stable, and (3) the fuel does not cross the membrane. Development of this polymer AEM is rapidly removing engineering barriers to development of practical direct liquid alkaline fuel cells.

### REFERENCES

1. Zhu, Y.; Ha, S. Y.; Masel, R. I., High power density direct formic acid fuel cells. Journal of Power Sources 2004, 130, (1-2), 8-14.
2. Antolini, E., Catalysts for direct ethanol fuel cells. Journal of Power Sources 2007, 170, (1), 1-12.
3. Liu, H. S.; Song, C. J.; Zhang, L.; Zhang, J. J.; Wang, H. J.; Wilkinson, D. P., A review of anode catalysis in the direct methanol fuel cell. Journal of Power Sources 2006, 155, (2), 95-110.
4. Christensen, P. A.; Hamnett, A.; Linares-Moya, D., The electro-oxidation of formate ions at a polycrystalline Pt electrode in alkaline solution: an in situ FTIR study. Physical Chemistry Chemical Physics 2011, 13, (24), 11739-11747.
5. Bianchini, C.; Shen, P. K., Palladium-Based Electrocatalysts for Alcohol Oxidation in Half Cells and in Direct Alcohol Fuel Cells. Chemical Reviews 2009, 109, (9), 4183-4206.
6. Bianchini, C.; Bambagioni, V.; Filippi, J.; Marchionni, A.; Vizza, F.; Bert, P.; Tampucci, A., Selective oxidation of ethanol to acetic acid in highly efficient polymer electrolyte membrane-direct ethanol fuel cells. Electrochemistry Communications 2009, 11, (5), 1077-1080.
7. Li, Y. S.; Zhao, T. S.; Liang, Z. X., Performance of alkaline electrolyte-membrane-based direct ethanol fuel cells. Journal of Power Sources 2009, 187, (2), 387-392.
8. Bambagioni, V.; Bianchini, C.; Marchionni, A.; Filippi, J.; Vizza, F.; Teddy, J.; Serp, P.; Zhiani, M., Pd and Pt—Ru anode electrocatalysts supported on multi-walled carbon nanotubes and their use in passive and active direct alcohol fuel cells with an anion-exchange membrane (alcohol=methanol, ethanol, glycerol). Journal of Power Sources 2009, 190, (2), 241-251.
9. Yu, E. H.; Krewer, U.; Scott, K., Principles and Materials Aspects of Direct Alkaline Alcohol Fuel Cells. Energies 2010, 3, (8), 1499-1528.
10. Liang, Z. X.; Zhao, T. S.; Xu, J. B.; Zhu, L. D., Mechanism study of the ethanol oxidation reaction on palladium in alkaline media. Electrochimica Acta 2009, 54, (8), 2203-2208.
11. Jacobsen, E.; Roberts Jr, J. L.; Sawyer, D. T., Electrochemical oxidation of formate in dimethylsulfoxide at gold and platinum electrodes. Journal of Electroanalytical Chemistry and Interfacial Electrochemistry 1968, 16, (3), 351-360.
12. Takamura, T.; Mochimaru, F., Adsorption and oxidation of formate on palladium in alkaline solution. Electrochimica Acta 1969, 14, (1), 111-119.
13. Taberner, P.; Heitbaum, J.; Vielstich, W., The influence of the electrolyte composition on the formate oxidation in alkaline formate-air fuel cells. Electrochimica Acta 1976, 21, (6), 439-440.
14. Hellsten, P. P.; Salminen, J. M.; Jorgensen, K. S.; Nysten, T. H., Use of Potassium Formate in Road Winter Deicing Can Reduce Groundwater Deterioration. Environmental Science & Technology 2005, 39, (13), 5095-5100.
15. Schaub, T.; Paciello, R. A., A Process for the Synthesis of Formic Acid by CO2 Hydrogenation: Thermodynamic Aspects and the Role of CO. Angewandte Chemie International Edition 2011, 50, (32), 7278-7282.
16. Agarwal, A. S.; Zhai, Y.; Hill, D.; Sridhar, N., The Electrochemical Reduction of Carbon Dioxide to Formate/Formic Acid: Engineering and Economic Feasibility. ChemSusChem 2011, 4, 1301-1310.
17. Arai, T.; Tajima, S.; Sato, S.; Uemura, K.; Morikawa, T.; Kajino, T., Selective CO2 Conversion to Formate in Water Using a CZTS Photocathode Modified with a Ruthenium Complex Polymer. Chem. Commun. 2011, 47, 12664-12666.
18. Kjeang, E.; Michel, R.; Harrington, D. A.; Sinton, D.; Djilali, N., An alkaline microfluidic fuel cell based on formate and hypochlorite bleach. Electrochimica Acta 2008, 54, (2), 698-705.
19. Larsen, R.; Ha, S.; Zakzeski, J.; Masel, R. I., Unusually active palladium-based catalysts for the electrooxidation of formic acid. Journal of Power Sources 2006, 157, (1), 78-84.
20. Bin, W., Recent development of non-platinum catalysts for oxygen reduction reaction. Journal of Power Sources 2005, 152, (0), 1-15.
21. Balarew, C., Dirkse T. P., Golubchikov; O. A., Salomon, M., Eds., IUPAC-NIST Solubility Data Series. 73. Metal and Ammonium Formate Systems. J. Phys. Chem. Ref. Data 2001, 30, (1).
22. Ha, S.; Larsen, R.; Zhu, Y.; Masel, R. I., Direct formic acid fuel cells with 600 mA.cm-2 at 0.4 V and 22 DegC. Fuel Cells 2004, 4, (4), 337-343.
23. Zhang, Z.; Xin, L.; Sun, K.; Li, W., Pd—Ni electrocatalysts for efficient ethanol oxidation reaction in alkaline electrolyte. International Journal of Hydrogen Energy 2011, 36, (20), 12686-12697.
24. Haan, J. L.; Stafford, K. M.; Masel, R. I., Effects of the Addition of Antimony, Tin, and Lead to Palladium Catalyst Formulations for the Direct Formic Acid Fuel Cell. The Journal of Physical Chemistry C 2010, 114, (26), 11665-11672.

### SUMMARY OF THE INVENTION

An example of an alkaline direct liquid fuel cell is shown in FIG. 1, where the fuel, F, is oxidized to carbon dioxide and water at the anode, while oxygen is reduced at the cathode. The alkaline anion exchange membrane is a key component and passes hydroxide ion from cathode to anode; the combination of fuel and hydroxide at the anode releases electrons, which flow out of the fuel cell to do the work of powering a mobile phone, for example. As electrons flow to the cathode, the oxygen is reduced and hydroxide is released and transferred across the membrane. The electrodes consist of catalysts in direct contact with the membrane via an application method such as painting or indirect contact via some other medium, such as a gas diffusion electrode hot pressed to the membrane.

The most popular fuel to date, in part due to its renewability, is ethanol:

CH₃CH₂OH+12OH⁻→2CO₂+9H₂O+12e⁻E_{anode}⁰=−0.74V (8)

As expected, the ethanol oxidation reaction is more facile in alkaline media than it is in acid media, but it still exhibits a high overpotential and the oxidation to CO₂ is generally incomplete (see Liang—Ref. 10). Despite these drawbacks, alkaline direct ethanol fuel cells (DEFCs) with polymer AEMs have been demonstrated to produce significant power density with optimization of catalysts (including non-platinum metals) and fuel/electrolyte concentrations (see Bianchini—Ref. 5).

Methanol also has been studied as a fuel for an AFC:

CH₃OH+6OH⁻→CO₂+5H₂O+6e⁻ E_{anode}⁰=−0.81V (9)

A major advantage to using methanol in an alkaline fuel cell rather than an acid fuel cell (Equation 6) is that water is produced (rather than required) at the anode. The water requirement in the acid methanol fuel cell demands a prohibitive water management system which significantly reduces the net power output of the fuel cell. In addition, the methanol oxidation reaction is more likely to go to completion than ethanol oxidation due to the lack of carbon-carbon bond, and its oxidation mechanism is currently the focus of much research (see Christensen—Ref. 4). However, methanol oxidation is also subject to high overpotential, which limits its power density (see Bianchini—Ref. 6; Bambagioni—Ref. 8). In addition, its toxicity and flammability reduce its attractiveness as a fuel.

The oxidation of sodium formate and potassium formate was studied several decades ago and shown in alkaline media to oxidize readily on palladium, which is less costly than platinum (see Jacobsen—Ref. 11; Takamura—Ref. 12; Tabemer—Ref. 13).

COOH⁻+3OH⁻→CO₃²⁻+2H₂O+2e⁻ E_{anode}⁰=−1.05V (10)

Combination of Equations 5 and 10 would produce an overall theoretical E_{cell}⁰ of 1.45 V, which is 0.31V higher than an alkaline DEFC and 0.24 V higher than an alkaline DMFC. In alkaline media, formate salts do not exhibit any poisoning and are expected to oxidize efficiently on even less costly catalysts than palladium. Potential alternative catalyst metals include Pd, Pt, Ru, Ir, Au, Ag, Fe, Ni, Co, Zn, V, Sn, Pb, and Sb

One can envision a formate fuel which is transported conveniently in a solid form and dissolved in water at the point of energy demand to produce a usable fuel. These two formate salts are not dangerous to humans or the environment. Formate solutions are used as airplane and road de-icing agents due to their environmentally-friendly and non-corrosive properties; chloride salts currently used in road de-icing contaminate aquifers and corrode vehicles and bridges (see Hellsten—Ref. 14). Sodium formate is approved as a food additive in the United States. There is current research on conversion of carbon dioxide to small organic molecule fuels such as formic acid and methanol (see Schaub—Ref. 15). Combined with contemporary research on artificial photosynthesis, the conversion of carbon dioxide into usable small organic molecule fuels would directly create a renewable source of formate salts (see Agarwal—Ref. 16; Arai—Ref. 17). In addition to their safety and potential renewability, formate salts are non-flammable in contrast to alcohol fuels.

In the 1970s, formate-air fuel cells were studied using KOH and NaOH liquid electrolytes (see Tabemer—Ref. 13). Recently, a microfluidic fuel cell was demonstrated using formate as the fuel and hypochlorite bleach as the oxidant (see Kjeang—Ref. 18). However, no known fuel cell device demonstrates the combination of formate fuels with oxygen or air separated by a polymer alkaline anion exchange membrane. Therefore, we present here the first description to our knowledge of a direct formate fuel cell (DFFC) employing at least one formate as the anode fuel, either air or oxygen as the oxidant, a polymer anion exchange membrane (AEM) to separate the anode and cathode, and metal catalysts at the anode and cathode.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a conceptual diagram of an alkaline direct liquid fuel cell showing the fuel oxidizing to water and carbon dioxide at the anode and oxygen reducing at the cathode. A key component of this fuel cell is the polymer membrane which transfers hydroxide ions from the cathode to anode;

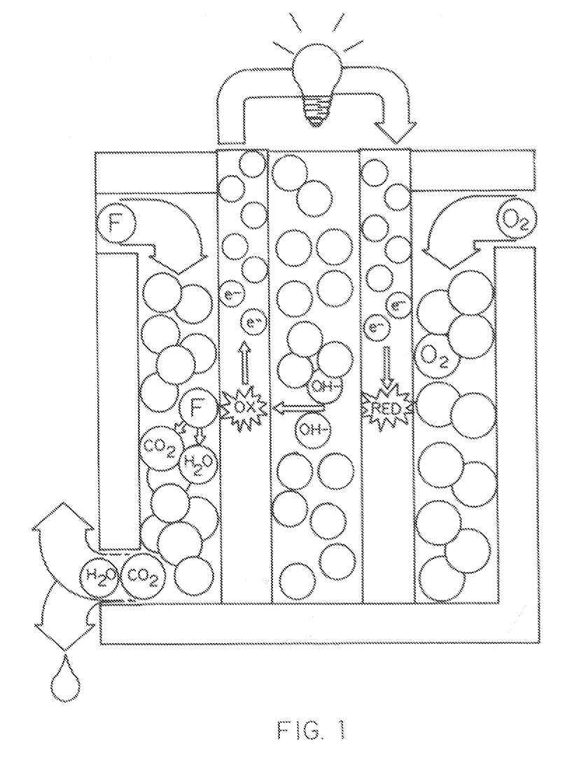

FIG. 2 provides VI plots comparing effects of KOH fuel electrolyte concentration in the DFFC. The optimal KOH concentration is 2 M, although significant power density can be achieved without KOH added to the fuel stream. Fuel: 1 mL min⁻¹ KCOOH+0-2 M KOH. Oxidant: 100 sccm dry oxygen at 25° C. Temperature of fuel and fuel cell: 60° C.;

FIG. 3 provides VI plots comparing effects of KCOOH fuel concentration in the DFFC. The optimal KCOOH concentration is 1M, and some decrease in fuel cell performance is demonstrated at 3 M. Fuel: 1 mL min⁻¹ 1-3 M KCOOH+2 M KOH. Oxidant: 100 sccm dry oxygen at 25° C. Temperature of fuel and fuel cell: 60° C.;

FIG. 4 provides VI plots comparing effects of formate counter ion and temperature in the DFFC. The KCOOH fuel demonstrates a higher power density than NaCOOH at 60° C. or KCOOH at 40° C. Fuel: 1 mL min⁻¹ 1M KCOOH+2 M KOH -or- 1M NaCOOH+2 M KOH. Oxidant: 100 sccm dry oxygen at 25° C. Temperature of fuel and fuel cell: 40° C. -or- 60° C.;

FIG. 5 provides VI plots comparing the DFFC with air or oxygen to the DEFC with air or oxygen. The DFFC powered by KCOOH demonstrates a higher power density than a DEFC using the same MEA powered by ethanol. Each fuel cell produces more power in oxygen than in air. Fuel: 1 mL min⁻¹ 1M KCOOH+2 M KOH -or- 2 M ethanol+2 M KOH. Oxidant: 100 sccm dry oxygen -or- 400 sccm dry air. Temperature of fuel and fuel cell: 60° C.;

FIG. 6 is a graph of a 5+ hour constant current test using the same MEA in a DFFC and a DEFC. The DFFC is relatively stable just below 600 mV at 100 mA cm⁻². Fuel: 0.2 mL min⁻¹ 1M KCOOH+2 M KOH -or- 2 M ethanol+2 M KOH. Oxidant: 100 sccm dry oxygen. Temperature of fuel and fuel cell: 60° C.; and

FIG. 7 is a graph of fifteen hour constant potential experiments in an electrochemical cell using a palladium black working electrode rotating at 2000 rpm. The oxidation of formate is quite stable over several hours and its oxidation rate is significantly greater than that of ethanol or formic acid at comparable applied potentials.

### DETAILED DESCRIPTION OF PREFERRED EMBODIMENTS

### Experimental

An exemplary fuel cell assembly in accordance with an embodiment of the present invention, consists of a test cell (Fuel Cell Technologies, 5 cm² active area) and a membrane electrode assembly consisting of an alkaline anion exchange membrane (Tokuyama, A201), palladium black anode catalyst (Aldrich, 99.8%), and platinum black cathode catalyst (Alfa Aesar, high surface area).

To create the cathode catalyst ink, 34 mg platinum black is mixed with 300 mg water and approximately 110 mg alkaline ionomer solution (Toktiyama, 5 wt % AS-4). An appropriate amount of this catalyst ink is directly painted onto the membrane in order to load approximately 2 mg cm⁻² of platinum. (The remainder of the ink is discarded. A smaller volume of ink is challenging to mix thoroughly.) The mass ratio of ionomer to catalyst is approximately 1:6. Care is taken to paint an even catalyst layer onto the membrane.

To create the anode catalyst ink, 34 mg palladium black is mixed with the same amount of water and ionomer as the cathode catalyst ink. An appropriate amount of this catalyst ink is directly painted onto the membrane in order to load approximately 2 mg cm⁻² of palladium.

A gas diffusion layer, untreated carbon cloth (Fuel Cell Stores), is assembled with the membrane, as well as a nylon spacer, which prevents crushing of the gas diffusion layer. Once the fuel cell is assembled, it is connected to a DC load box (BK Precision, 8500). Liquid solution of KCOOH/KOH, NaCOOH/KOH, or CH₃CH₂OH/KOH is directly fed to the anode at approximately 1 mL min⁻¹ for potential-current (VI) tests and approximately 0.2 mL min⁻¹ for constant current tests. The cathode is fed dry oxygen (Oxygen Service Company) at 100 sccm or dry air (Oxygen Service Company) at 400 sccm. The fuel cell assembly and the liquid fuel are both heated to 40 or 60° C., while the cathode gas is unheated. (Heating the cathode gas only increases the fuel cell current output by approximately 1%.) For the VI experiments, the fuel cell is stepped from open circuit potential to approximately 0.4 V. The constant current experiment is set at 100 mA cm⁻² for several hours.

A second exemplary fuel cell contains a carbon-supported cathode catalyst ink mixture. For this mixture, 150 mg of base metal, carbon-supported catalyst (ACTA 4020 series, ˜3.5 wt % transition metal) is mixed with 1 g isopropyl alcohol and 30 mg of ionomer. When the entirety of this ink is painted, it leads to a loading of approximately 1 mg cm⁻² metal.

A third exemplary fuel cell contains a carbon-supported anode catalyst ink mixture. For this mixture, 20 mg of carbon-supported palladium catalyst is mixed with 1 g isopropyl alcohol and 30 mg of ionomer. When the entirety of this ink is painted, it leads to a loading of approximately 2 mg cm⁻² palladium.

An exemplary formate fuel mixture consists of 2 M KOH and 1 M KCOOH, dissolved in water. The KOH is used as an electrolyte to enhance performance, but it is not necessary for operation of the fuel cell. Any reasonably soluble metal or ammonium/amine-based ion could be used as the cation, Cat, for the electrolyte (CatOH) or the fuel (CatCOOH).

Electrochemical cell experiments are carried out with a potentiostat (Ametek, PAR263A) in a standard three electrode glass cell. The working electrode consists of palladium black catalyst (Aldrich, 99.8%) applied to a gold tip attached to a rotating disk electrode (Pine Instruments, AFMSRCE). The catalyst ink is comprised of 5.6 mg palladium black, 1 g water (Millipore, 18 MΩ cm), and ˜20 mg binder (Neon, 5 wt %). The counter electrode is platinum mesh (Alfa Aesar, 52 mesh). The reference electrode is Ag/AgCl (eDAQ, leakless). The reference electrode is monitored daily to insure that there was no precipitation of AgOH which would result in electrode drift.

Chronoamperometry experiments at various potentials are performed to observe the behavior of the catalysts over 15 hours in three different 1M solutions (and 1M support electrolytes): KCOOH (KOH), CH₃CH₂OH (KOH), and HCOOH(H₂SO₄). Each solution is degassed using argon (UHP, Oxygen Service Company). The rotating disk is operated at 2000 rpm to remove carbon dioxide bubble formation from the working electrode and prevent concentration gradients in solution.

### Demonstration of the Direct Formate Fuel Cell

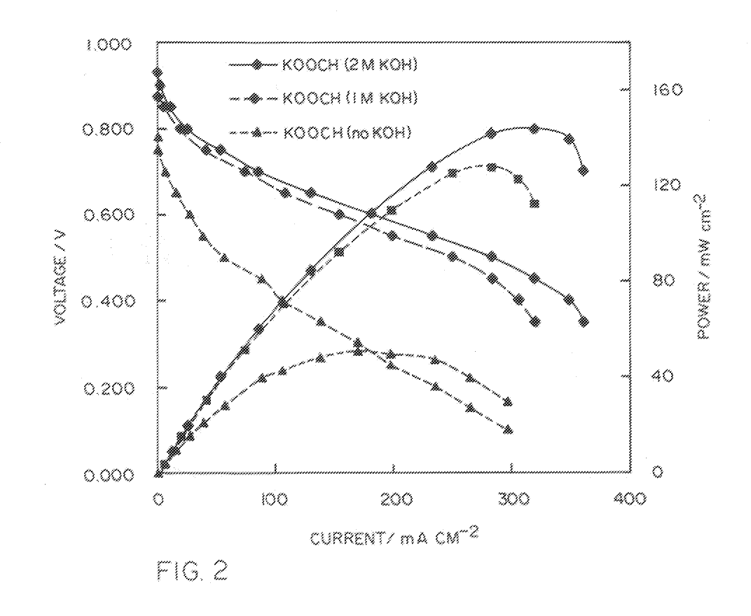

We demonstrate for the first time an operating direct formate fuel cell (DFFC) employing at least one formate salt as the anode fuel, either air or oxygen as the oxidant, a polymer anion exchange membrane to separate the anode and cathode, and metal catalysts at the anode and cathode. FIG. 2 shows operation of the DFFC with 1M KOOCH+2 M KOH as the anode fuel and electrolyte, oxygen as the cathode, and the fuel cell operating at 60° C. Under these conditions the DFFC peak power density is 144 mW cm⁻², the current density at 0.6 V is 181 mA cm⁻², and the open circuit voltage is 0.931V. This performance is competitive with alkaline DLFCs reported in the literature (up to 125 mW cm⁻² at 60° C.) and demonstrates that formate fuel is a legitimate contender with alcohol fuels for alkaline DLFCs (see Bianchini—Ref. 5; Yu—Ref. 9).

We use a proof-of-concept membrane electrode assembly (MEA) consisting of 2 mg cm⁻² palladium black anode catalyst and 2 mg cm⁻² platinum black cathode catalyst directly painted onto a Tokuyama A201 alkaline AEM. Palladium black is used at the anode because it is known to be an excellent catalyst for formic acid oxidation (see Kjeang—Ref. 18). Research confirms it is also a powerful and stable catalyst for formate oxidation. This MEA was also used with ethanol fuel to compare the DFFC to a DEFC since palladium has been demonstrated as a strong catalyst for ethanol oxidation in alkaline media. We anticipate that future research on the DFFC catalysts and other components will produce a higher-performing DFFC which will continue to compete with the DEFC.

### Dependence on KOH Concentration

FIG. 2 shows the role of 0-2 M KOH mixed with 1M KCOOH as the anode fuel in a DFFC operating at 60° C. with dry oxygen at the cathode. A concentration of 2 M KOH was found to be optimal, therefore it was used in all other experiments. When the KCOOH anode fuel was used without any addition of KOH, the performance was significantly weakened. Current alkaline fuel cells require some hydroxide ion to be mixed with the fuel since they are a reactant in the oxidation of the fuel (Equations 8-10) (see Yu—Ref. 9). Theoretically, sufficient hydroxide ion is produced at the cathode and should be transferred across the membrane to the anode. However, until a more efficient membrane is developed, some hydroxide mixed with the fuel will increase efficiency. It is important to note in FIG. 2 that, although the fuel cell performance decreases when KOH is removed from the fuel, significant performance (51 mW cm⁻²) is still achieved. This performance will be discussed again below in comparison to the ethanol fuel cell. A DFFC with a fully optimized membrane should not require any KOH in the fuel. Therefore, a formate salt could be transported and stored in the solid form; it might even be inserted into the fuel cell in the solid form. In this case, the fuel cell would simply have the requirement to “just add water” in order to operate. Formate salts are promising fuels with improved DFFC engineering.

### Dependence on KOOCH Concentration

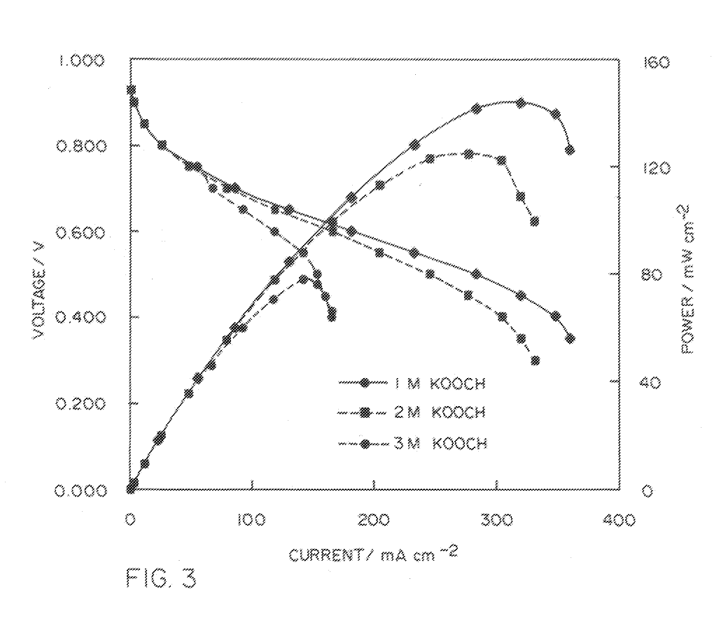

FIG. 3 shows the effect of changing the KOOCH concentration in a DFFC operating at 60° C. using dry oxygen at the cathode and 2 M KOH mixed with the anode fuel. A concentration of 1M KOOCH was determined to be optimal at these conditions, while increasing the concentration to 3 M KOOCH significantly decreased. DFFC performance. The solubility of potassium formate in water is 39.4 mol kg⁻¹ at 18° C.; an ideal fuel cell would take advantage of this by operating at a high concentration of potassium formate (see Balarew—Ref. 21). Our fuel cell shows that increasing concentration of potassium formate to 3 M, less than a tenth of its maximum solubility, significantly diminishes performance. It has been reported that 5 M ethanol is the concentration at which alkaline DEFC performance reaches a maximum, because as the ethanol concentration increases, adsorption of hydroxyls (consumed in the rate determining step) blocks ethanol adsorption (see Li—Ref. 7). It is possible that the same competitive adsorption is occurring during formate oxidation.

### Dependence on Temperature and Counterion

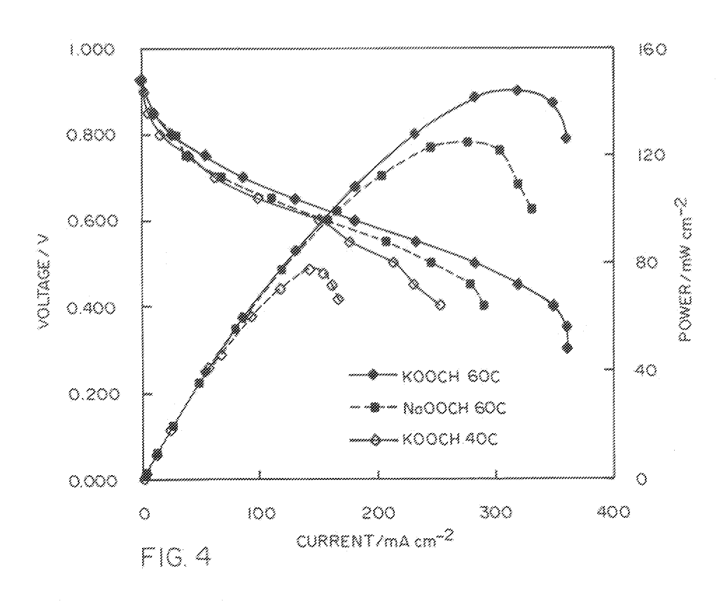

The VI plots in FIG. 4 demonstrate a significantly higher peak power density (144 vs. 78 mW cm⁻²) when the DFFC is run with KCOOH at 60° C. rather than 40° C. These results are similar to published results for the DEFC, which also requires 60-80° C. to achieve optimal performance (see Jacobsen—Ref. 11). We expect that this temperature dependence is partially due to the membrane and not entirely due to kinetics. The formic acid fuel cell was shown to be capable of operating at low temperatures (at or near room temperature) (see Ha—Ref. 22). We anticipate that formate oxidation also will occur efficiently at low temperatures once the membrane is optimized.

The VI plots shown in FIG. 4 also compare formate counter ion when the DFFC is run with a dry oxygen cathode and 2 M KOH mixed with the anode fuel. A DFFC using KCOOH anode fuel produces a slightly higher peak power density (144 vs. 125 mW cm⁻²) than NaCOOH anode fuel when run at 60° C. This trend is confirmed in an electrochemical cell. Since potassium formate is more soluble in water, this outcome is advantageous to future optimization of the DFFC.

### Comparison to Ethanol

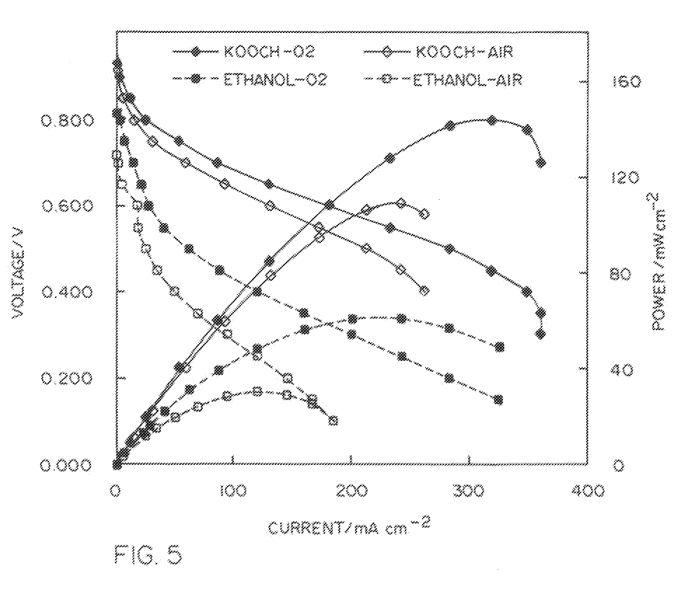

FIG. 5 shows VI plots which compare the DFFC using KCOOH to the direct ethanol fuel cell (DEFC) operated using the same MEA at 60° C. with dry oxygen or dry air at the cathode and 2 M KOH mixed with the anode fuel. As expected, the DFFC run with oxygen exhibits a higher peak power density than the DFFC run with air. The same comparison holds for the DEFCs. Yet there are three key findings in this figure:

(1) The open circuit voltage (OCV) is significantly higher in the DFFC (0.931V with oxygen; 0.913 V with air) compared with the DEFC (0.814 V with oxygen; 0.719 V with air). When Equation 10 is added to Equation 5, the overall theoretical E_{cell}⁰ is 1.45 V. However, in the ethanol fuel cell, when Equation 8 is added to Equation 5, the overall theoretical E_{cell}⁰ is 1.14 V, which is 310 mV lower. In practice, we find that the OCV is 117 mV higher in the DFFC when oxygen is used at the cathode, and 194 mV higher when air is used. The expected trend is expected and almost completely realized in the fuel cells using air as the oxidant.

(2) The current density at 0.6 V is nearly an order of magnitude greater in the DFFC (181 mA cm⁻² with oxygen; 131 mA cm⁻² with air) than the DEFC (27 mA cm⁻² with oxygen; 17 mA cm⁻² with air). The slope of the Ohmic region of the VI curve in the formate fuel cell is similar to that of the ethanol-oxygen fuel cell, which is to be expected since the same MEA is used in each case. However, the kinetic activation losses appear to be worse for the ethanol fuel cells (from ˜0.8 to 0.6 V) than they are in the formate fuel cells (from ˜0.9 to 0.8 V). Therefore, the difference in current at 0.6 V is due to the thermodynamic differences between Equations 8 and 10 in addition to kinetic losses that are observed in VI curves.

Another perspective on the differences comes from considering how many millivolts are produced by the fuel cells at the same current: ˜200 mA cm⁻²; the oxygen-DFFC produces 580 mV, the air-DFFC produces 515 mV, and the oxygen-DEFC produces 300 mV. One reason for these losses is likely due to the fact that Equation 5 is a theoretical description of what occurs in a DEFC. However, the DEFC in practice does not completely oxidize the ethanol fuel. While this was a major concern in acid fuel cells, it is less concerning in alkaline fuel cells because the reaction proceeds more rapidly in an alkaline environment. However, the majority of the ethanol is still not converted to carbon dioxide by breaking the carbon-carbon bond; in alkaline media it mostly oxidizes to acetaldehyde or acetic acid (see Liang—Ref. 10). Thus the full potential of the ethanol molecule is still not realized.

At this point, it is important to make a different comparison: the DFFC reported here compares well with recent reports on the DEFC in literature. Using a palladium-based anode and a K-14 Hypermec (non-platinum) cathode separated by a Tokuyama A-006 membrane, Bianchini, et al, developed a DEFC which produces 125 mW cm⁻² at 60° C. and ˜50 mA cm⁻² at 0.6 V (see Bianchini—Ref. 6). This is greater than our performance with ethanol, but we still find that our formate fuel cell is competitive with this well-performing DEFC.

(3) The DFFC produces more than double the peak power density (144 vs. 61 mW cm⁻²) than the DEFC when dry oxygen is used at the cathode. Even the DFFC using cathode air produces double the peak power density (125 vs. 61 mW cm⁻²) of the DEFC using cathode oxygen. Many of the alkaline AEM fuel cells reported in the literature to date require the use of oxygen at the cathode in order to achieve practical performance levels (see Bianchini—Ref. 5). Improved polymer membranes are likely to make the use of cathode air more viable in the future, yet it is significant to observe that the DFFC performance is still substantial when air is used as the oxidant.

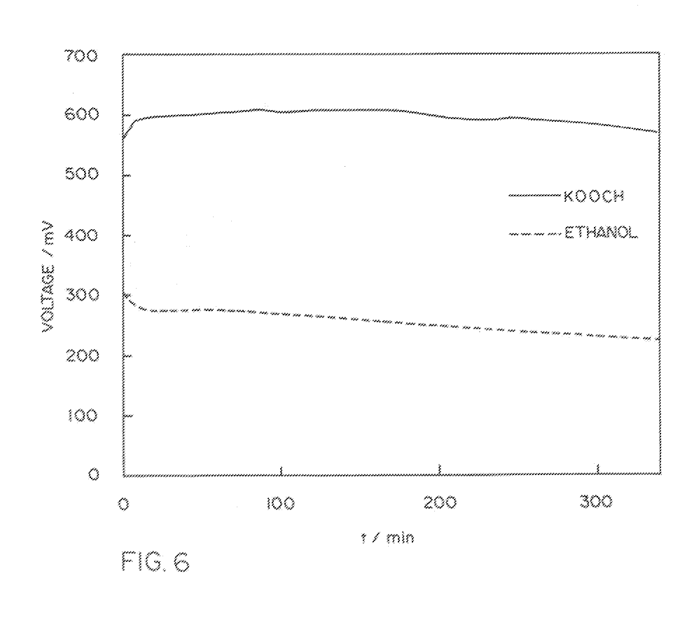

FIG. 6 shows a five-hour constant current test at 100 mA cm⁻² in a DFFC and a DEFC operating at 60° C. using dry oxygen at the cathode and 2 M KOH mixed with the anode fuel. The DFFC using KCOOH decreases from 590 mV at 10 min to 585 mV at 5 hours. The DEFC decreases from 280 mV at 10 min to 233 mV at 5 hours. Therefore, at 5 hours, the DFFC voltage is 2.5 times greater than the DEFC voltage. Although the DFFC is not yet optimized for long durations, it is evident that stable performance can be expected.

FIGS. 2-6 demonstrate the first DFFC employing formate salts as the anode fuel, air or oxygen as the oxidant, a polymer AEM to separate the anode and cathode, and metal catalysts at the anode and cathode. Some of the key findings are summarized in Table 1. The purpose of this work is not to discredit the ethanol fuel cell. Ethanol is a very attractive fuel due to its renewability, and the alkaline polymer membrane makes ethanol a viable fuel for a DLFC. In addition, it is acknowledged here that the DEFC used in this work is not optimized. However, this work uses a proof-of-concept MEA, which contains catalysts known to efficiently oxidize ethanol and reduce oxygen. The comparisons between the fuels are meant to demonstrate the fact that formate fuel is competitive with ethanol and has several theoretical advantages which are borne out in practice when the same MEA is used to create a close comparison.

Table 1—Summary of key fuel cell data. The DFFC with 2 M KOH mixed with 1M KCOOH produces peak power densities of 144 mW cm⁻² with oxygen and 125 mW cm² with air. When KOH is removed from the fuel stream, the DFFC peak power density decreases to 51 mW cm⁻². When the same MEA is used in a DEFC with KOH added to the fuel the peak power density is 61 mW cm⁻².

TABLE 1

| | | Peak Power | | |
|---|---|---|---|---|
| | Cathode | Density | Current Density | OCV |
| Anode Fuel/Electrolyte | Oxidant | (mW cm⁻²) | (0.6 V, mA cm⁻²) | (V) |
| 1M KCOOH/2M KOH | Oxygen | 144 | 181 | 0.931 |
| 1M KCOOH/2M KOH | Air | 125 | 131 | 0.913 |
| 2M Ethanol/2M KOH | Oxygen | 61 | 27 | 0.814 |
| 1M KCOOH | Oxygen | 51 | 26 | 0.780 |

### Half-Cell Fuel Comparison

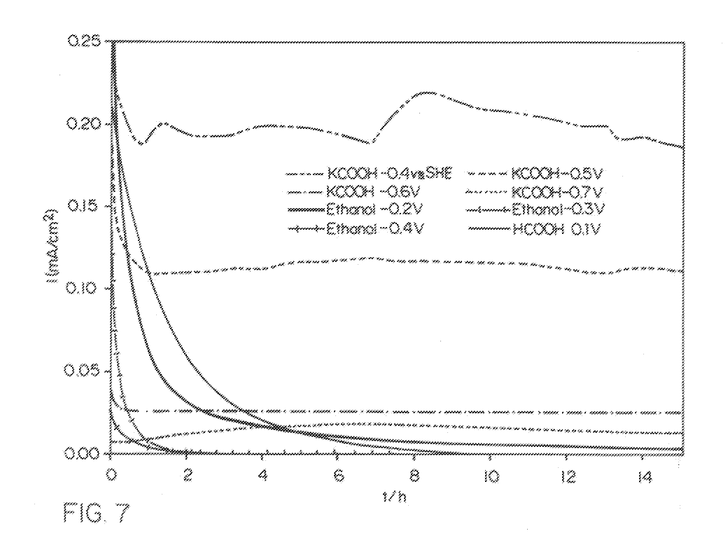

Ultimately, the motivation for this work comes from FIG. 7, which shows the oxidation current of each fuel with electrolyte (1M KCOOH+1M KOH, 1M ethanol+1M KOH, or 1M HCOOH+1M H₂SO₄) on palladium at various potentials in an electrochemical cell. We observe that, compared with ethanol, potassium formate is oxidized more efficiently, at lower potentials, and with a more stable oxidation rate. The oxidation rates after 15 h are summarized in Table 2. After 15 h, the potassium formate oxidation rate is 1-2 orders of magnitude greater than the ethanol oxidation rate at all potentials. Recall that the difference between Equations 8 and 10 is 310 mV. Therefore, one would not expect formate and ethanol to oxidize at the same rate at the same potential; one would expect to apply an ˜300 mV more positive potential to ethanol to achieve a comparable oxidation rate. However, when we apply -0.5 V to potassium formate and −0.2 V to ethanol (i.e., 300 mV more positive), we make two important observations. First, we note that at short time periods (less than 1 h), the ethanol oxidation rate is somewhat greater, but this lasts only until ˜0.5 h. Next, we note that after approximately 1 h, the potassium formate oxidation rate stabilizes, while the ethanol oxidation rate continues to decay. After 15 h, we observe that the potassium formate oxidizes ˜40 times faster than ethanol. A poisoning intermediate has been reported for ethanol oxidation, and it is possible that is causing the decay over several hours which we observe here (see Zhang—Ref. 23). Note that these sluggish reactions should not be diffusion-limited in the electrochemical cell, so they are not governed by the Cottrell equation, which predicts a current decay which is inversely related to t^{1/2}. In addition, a rotating disk is used to 1) remove carbon dioxide bubble formation from the working electrode and 2) prevent concentration gradients in solution which might create a diffusion-limited environment. The shape of the potassium formate curves largely supports that of a kinetically-limited reaction on a rapidly regenerated catalyst surface, but the shape of the ethanol curves indicates a fouling of the electrode surface, particularly at longer time periods.

Table 2—The oxidation rate at 20 h for 1M KCOOH+1M KOH -or- 1 M ethanol+1M KOH in the electrochemical cell at various potentials on palladium catalyst. The potassium formate solutions are oxidized far more efficiently than the ethanol.

TABLE 2

| | Potential | Current Density |
|---|---|---|
| Fuel | (V vs SHE) | (15 h, mA cm⁻²) |
| Potassium | −0.4 V | 0.187 |
| formate | −0.5 V | 0.112 |
| | −0.6 V | 0.0255 |
| | −0.7 V | 0.0128 |
| Ethanol | −0.2 V | 0.00299 |
| | −0.3 V | ~0 |
| | −0.4 V | ~0 |

FIG. 7 also shows that potassium formate oxidation occurs at a much more stable rate than formic acid oxidation. At 15 h, the oxidation rate of potassium formate is much greater than that of formic acid; the analogous potentials for these methods are 0.1V for formic acid and −0.7 V for formate, according to the Nernst equation. Formic acid is prone to poisoning by the CO molecule, particularly in the presence of Nafion®, which is used as a binder in these experiments (as well as in the formic acid fuel cell). Previous work showed that oxidation of 12 M formic acid resulted in poison formation which covered nearly 60% of the palladium surface after only 3 hours (see Haan—Ref. 24). FIG. 7 supports the hypothesis that no significant poison is forming on the palladium surface during potassium formate oxidation at potentials which are of interest to operation of the DFFC.

### CONCLUSION

The present invention comprises an operating direct formate fuel cell employing formate salts as the anode fuel, air or oxygen as the oxidant, a polymer AEM to separate the anode and cathode, and metal catalysts at the anode and cathode. Operation of the DFFC at 60° C. with 1M KOOCH+2 M KOH as the anode fuel and electrolyte and oxygen at the cathode produces 144 mW cm⁻² of peak power density, 181 mA cm⁻² current density at 0.6 V, and an open circuit voltage of 0.931V. This performance is competitive with alkaline DLFCs reported in the literature and demonstrates that formate fuel is a legitimate contender with alcohol fuels for alkaline DLFCs.

Formate is an attractive fuel for alkaline DLFCs for several reasons: (1) formate is more kinetically active for electrooxidation on palladium in alkaline solution than acid solution (formic acid), (2) the DFFC has an overall theoretical potential of 1.45 V, which is 0.31 V higher than the DEFC (which runs on ethanol) and 0.24 V higher than the DMFC (which runs on methanol), (3) formate does not poison palladium in alkaline solutions, while acid DLFCs are susceptible to severe poisoning, (4) formate salts are safe and non-flammable, and (5) formate salts can be produced from renewable sources via artificial photosynthesis.

Those having skill in the fuel cell art will, as a result of the disclosure made herein, now perceive various improvements, modifications and the like in regard to the particular embodiments shown. Therefore, it should be understood that such embodiments are disclosed primarily for the purpose of explaining the structure, operation and advantages of the invention by examples and do not necessarily limit the scope hereof. The invention is limited only by the scope of the following claims and their legal equivalents.

I claim:

1. A direct formate fuel cell comprising a fuel chamber and an oxidant chamber separated by an alkaline membrane, said fuel chamber having at least one formate salt as the anode fuel, one said oxidant chamber having at least oxygen or air as an oxidizer, and metal catalysts at the anode and cathode, said fuel cell being configured for producing a current density output exceeding 150 mA cm⁻² at 0.6 V.

2. The direct formate fuel cell recited in claim 1 wherein said anode fuel contains sodium formate.

3. The direct formate fuel cell recited in claim 1 wherein said anode fuel contains potassium formate.

4. The direct formate fuel cell recited in claim 1 wherein said anode fuel contains ammonium formate.

5. The direct formate fuel cell recited in claim 1 wherein said anode fuel contains a soluble formate.

6. The direct formate fuel cell recited in claim 1 wherein the oxidant is Oxygen.

7. The direct formate fuel cell recited in claim 1 wherein the oxidant is air.

8. The direct formate fuel cell recited in claim 1 wherein said polymer anion exchange membrane comprises a solid polymer quaternary ammonium ionomer anion exchange membrane.

9. The direct formate fuel cell recited in claim 1 wherein said polymer anion exchange membrane is an alkaline membrane.

10. The direct formate fuel cell recited in claim 1 wherein said anode and said cathode comprise respective catalyst material layers on opposed surfaces of said polymer anion exchange membrane.

11. The direct formate fuel cell recited in claim 1 wherein said anode comprises a layer of metal nanoparticles in contact with one surface of the polymer anion exchange membrane.

12. The direct formate fuel cell recited in claim 11 wherein the metal nanoparticles contain unsupported palladium.

13. The direct formate fuel cell recited in claim 11 wherein the metal nanoparticles contain palladium on a support.

14. The direct formate fuel cell recited in claim 11 wherein the metal nanoparticles contain a metal taken from the group of metals consisting of Pt, Ru, Ir, Au, Ag, Fe, Ni, Co, Zn, V, Sn, Pb and Sb.

15. The direct formate fuel cell recited in claim 11 wherein the anode is configured to promote the oxidation of formate to CO₂ and water.

16. The direct formate fuel cell recited in claim 1 wherein said cathode comprises a layer of metal nanoparticles in contact with one surface of the polymer anion exchange membrane.

17. The direct formate fuel cell recited in claim 16 wherein the metal nanoparticles contain unsupported platinum.

18. The direct formate fuel cell recited in claim 16 wherein the metal nanoparticles contain platinum on a support.

19. The direct formate fuel cell recited in claim 16 wherein the metal nanoparticles contain a metal taken from the group of metals consisting of Pd, Au, Ag, Fe, Ni, Co and Zn.

20. The direct formate fuel cell recited in claim 16 wherein the cathode is configured to promote the reduction of an oxidant.
